(19) United States
(12) Patent Application Publication
(10) Pub. No.: US 2004/0218215 A1
(43) Pub. Date: Nov. 4, 2004

(54) Method and system for generating document packages for complex engineered equipment and mixed apparatus orders

(76) Inventors: Philip H. Van Sickel, Gibsonia, PA (US); Vinathan Swaminanthan, Oakdale, PA (US); John D. Mansor, Wexford, PA (US); Shankar Kumar, Moon Township, PA (US)

Correspondence Address: Martin J. Moran, Esquire, Cutler Hammer, Technology & Quality Center, RIDC Park West, 170 Industry Drive, Pittsburgh, PA, 15275-1032, US

(21) Appl. No.: 10/425,195

(22) Filed: Apr. 29, 2003

(51) Int. Cl. G06F 15/00; H04N 1/00

(52) U.S. Cl. 358/1.18; 358/1.12; 358/402

(57) ABSTRACT

Document packages for complex engineered equipment and mixed apparatus orders are generated automatically from documents stored in an electronic document library. The items ordered and type of package desired are entered through an order interface. Plant users have access to the items ordered and the electronic document library so that missing drawing documents can be added to the library. An editor identifies documents, including various types of drawings, needed for the ordered package, while a formatter selects an appropriate format for the package including selectable groupings of the ordered items, and therefore, of the documents. An electronic document print service gathers the order documents from the electronic document library to generate an electronic file that can be used to generate printed and/or CD-ROM document packages. The electronic file is placed on a server that can be accessed for remote printing by a commercial printer.

### BACKGROUND OF THE INVENTION

1. Field of the Invention

This invention relates to automation of the creation and printing or electronic delivery of order document packages such as operation and maintenance manuals, submittals, and shop drawings for complex engineered equipment and mixed apparatus orders. The documents can include textual, graphic and photographic materials in addition to drawings.

2. Background Information

Orders for equipment for large projects can call for dozens to hundreds of items from multiple product lines. Organizing and producing documentation on the ordered items is a challenging and time-consuming process. Various types of document packages need to be made available, each with a different set of required documents. For example, a submittal package consists of cut sheets from sales brochures, technical specifications, and drawings to support the mix of products in the job. Construction drawings indicate how the items are going to be manufactured. Operation and maintenance manuals consist of as-built drawings, standard drawings and publications. A single document package can require multiple volumes each containing several hundred pages.

Traditionally, the order documents have been prepared by the sales personnel. The sheer volume, variety and scattered sources of the required documents necessitate that sales personnel devote many, many hours to preparation and dissemination of these document packages. As each sales person or group develops an individual style, there is a lack of consistency to the document packages generated throughout an organization.

Some attempts have been made to reduce the burden on sales personnel in the preparation of order document packages. The development and use of a central electronic library of drawings has made it easier to locate and pull together the required drawings. Rule-based software selects and generates from the library an electronic file containing the drawings required for the items ordered. However, the sales person still has to organize the documents, specify paper for the individual documents and print-out or electronically produce the final product.

There is a need, therefore, for an improved method and system for generating order document packages that can further reduce the burden on the sales personnel while efficiently producing a complete package with up-to-date materials that has a uniform attractive look.

### SUMMARY OF THE INVENTION

This need and others are satisfied by the invention which is directed to a system and method for automatically generating document packages for complex engineered equipment and mixed apparatus orders. In general, the system comprises an order interface inputting an order document packaging including an identity of items ordered and a type of package ordered. An electronic transmittal file identifies recipients of the order document package. An electronic document library stores the documents associated with the items available for order including drawing documents. An editor identifies order documents needed for the order document package including drawing documents present in the electronic document library and any additional drawing documents needed but not in the electronic document library. A formatter establishes a selected format for the order documents for the type of package ordered. A plant interface provides access to the identity of items ordered and associated drawing documents in the electronic document library for inputting any additional drawing documents needed for the ordered document package. A document printing service generates from the electronic document library a file comprising the order documents and producing for the identified recipients an output of the order documents in the selected format.

The method comprises in a general sense, generating an electronic document library containing documents associated with items available for order including drawing documents, generating an electronic order file for an ordered document package comprising the identity of items ordered and the type of document package ordered, using the electronic order file to electronically identify ordered documents needed for the order document package including drawing documents present in the electronic document library and any additional drawing documents needed but not in the electronic library, establishing a format for the order documents based on the type of document package ordered, providing plant access to the identity of items ordered and to associated drawing documents in the electronic document library for inputting the additional drawing documents needed as order documents for the order document package, generating from the electronic document library an electronic order document file containing the order documents, and generating from the electronic order document file an output comprising the order documents in selected format.

### BRIEF DESCRIPTION OF THE DRAWINGS

A full understanding of the invention can be gained from the following description of the preferred embodiments when read in conjunction with the accompanying drawings in which:

FIG. 1 is a schematic diagram of the order document package generating system in accordance with the invention.

FIG. 2 is a flow chart implemented by the order document formatter and order document editor of the system of FIG. 1.

FIG. 3 is a flow chart for authorizing for printing function performed by the order document formatter.

FIG. 4 is a flow chart for the document release service of the system of FIG. 1.

FIG. 5 is a flow chart of the document print service of the system of FIG. 1.

### DESCRIPTION OF THE PREFERRED EMBODIMENTS

This invention relates to a method and system for generating order document packages for complex equipment and mixed apparatus orders. Reference will be made at times to application of the invention to producing order document packages for electric power distribution equipment; however, this is for illustrative purposes only as the invention is applicable to various types of complex equipment and mixed apparatus orders.

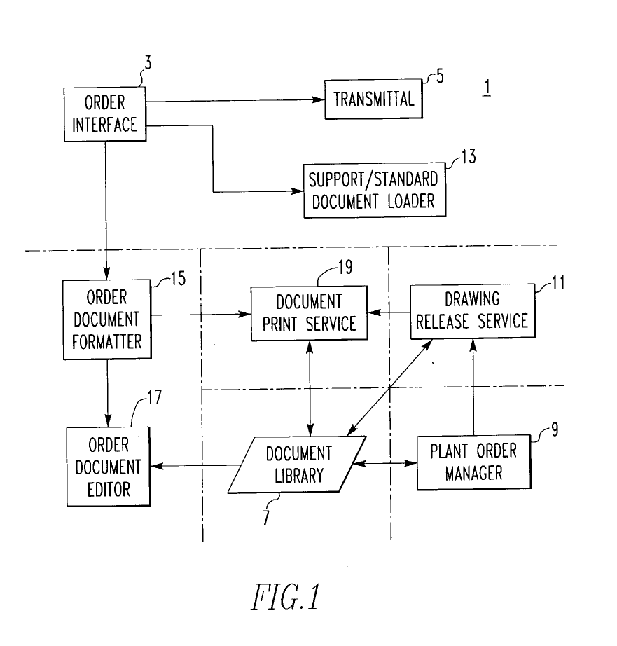

FIG. 1 provides an overview of the order document package generating system 1. The order interface 3 permits the sales person to input the order information into the system 1 as an electronic order file. This order interface 3 can be a terminal, but preferably is a negotiating software package that the sales person uses to generate the order information. The order information includes, for instance, identification of the parties involved, the job, addresses of recipients who are to receive the order document, the number of copies of the order document packaged to be produced, and the type of package such as printed and/or electronic. This information is stored in the transmittal module 5. All of the documents for generating the order document packages are stored in an electronic document library 7. Basically, there are two types of documents: drawings and other documents. The drawings include, for instance, submittal drawings, customer approval drawings, construction drawings and as-built drawings. The other documents include such things as advertising literature, bills of material, specification, test reports, component data, and operation and maintenance procedures.

Drawings are input and updated by plant personnel through a plant interface in the form of a plant order manager 9. Plant users create drawings and a Master Document Index (MDI) for loading into the electronic document library 7. The drawings prepared by the plant users are released into the electronic document library 7 by the drawing release service 11. This service validates the drawings to ensure that they meet specifications and loads them into the electronic document library 7. The drawing release service also automates requests for construction and customer approval drawings to expedite their production.

Documents other than drawings are input through the Supporting/Standard Document Loader 13 for storage in the electronic document library 7. This document loader 13 also houses the rules that, for instance, determine the make-up of each order document package. This includes, for instance, the standard documents that would be needed for each item that can be ordered. The standard document listings can be altered by the sales personnel through the order interface 3.

A formatter 15 establishes a selected format for the order documents for the type of package ordered. Two views are possible with this tool. In an item view, all of the items on the order are shown. In a product line view, the items are listed by product line in order. Groupings other than by product line can be set up. For instance, in the case of electronic power distribution equipment, the default grouping is by product line, so that, all panel boards, all circuit breakers, all bus work and so on are listed together. Alternatively, the items could be grouped according to building in a multi-building job, or by floor, or by some other classification. An order document editor 17 identifies the order documents needed for the order document package utilizing the rules provided by the Supporting/Standard Document Loader 13 for the type of document package ordered. Drawings that are needed but are not found in the electronic document library 7 are identified. Plant users have access through the editor to determine what additional drawings are needed. Plant users can then prepare these drawings and enter them through the plant order manager 9. If necessary documents, drawings as well as non-drawing documents are not available, the user can insert place holders for these documents in the package. For printed packages, blank pages will be generated as place holders for the missing documents.

When the user is satisfied with the document package and authorization is given for printing, a document printing service 19 generates an electronic order document file in the form of a consolidated PDF file of the order documents in the format selected and then transmits the PDF and transmittal files to the a specified FTP server so that it can be picked up by an authorized printer for printing and mailing. One of the advantages of this is that a commercial printer in a remote location can pick up the FTP file for printing. In addition to generating printed copies of the order document package, electronic copies can be e-mailed to the customer or transferred to an electronic storage medium such as a CD-ROM for delivery.

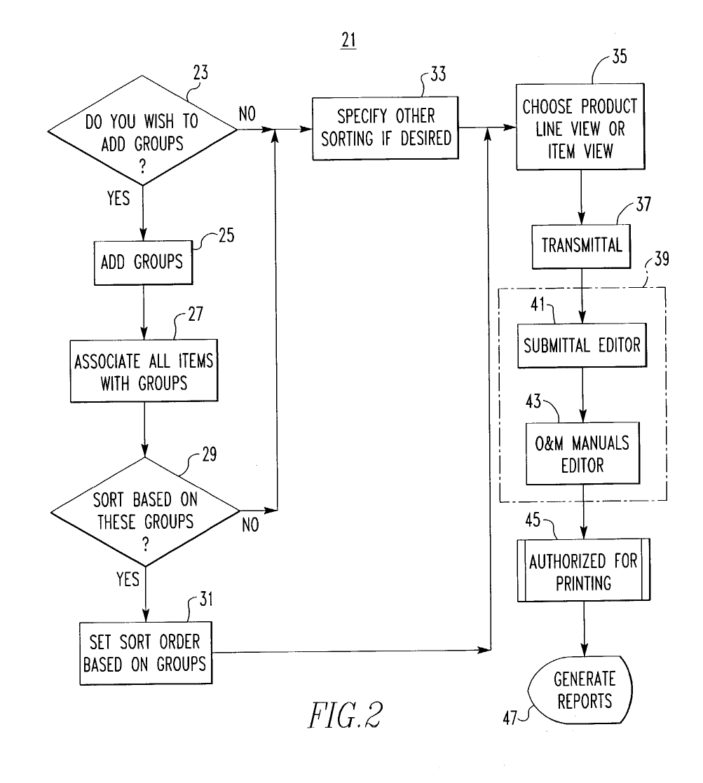

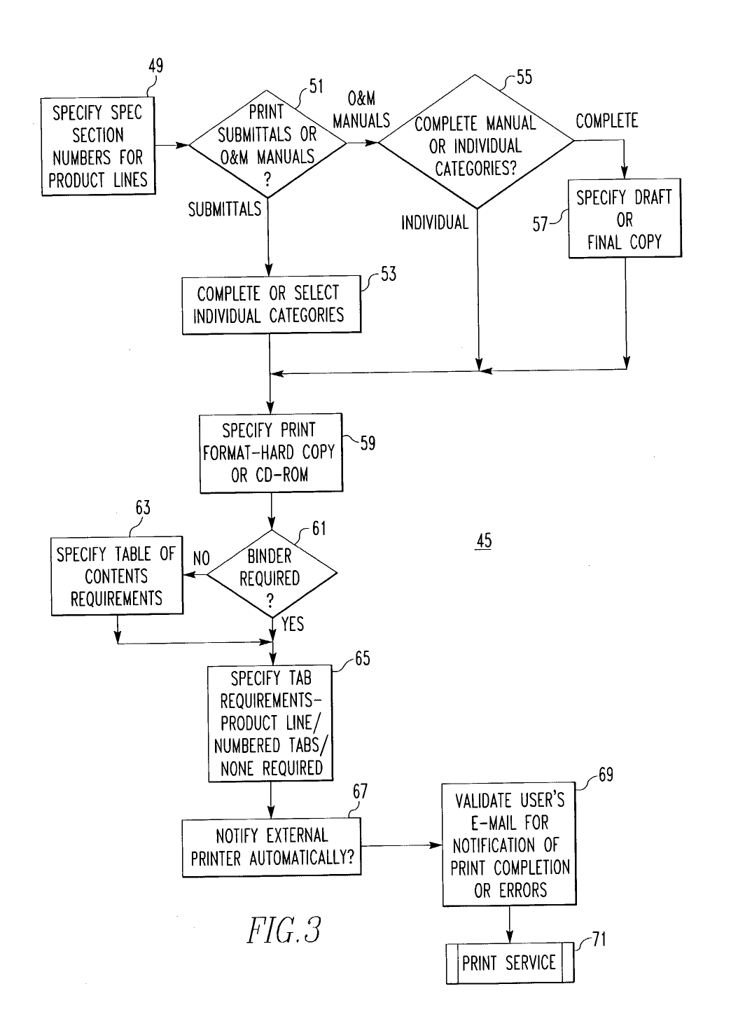

A generalized flow chart 21 for the order document formatter 15 is illustrated in FIG. 2. The formatter allows the user to add groups at 23 and 25 if desired. If this is done, all the items must be associated with a group at 27. The items can then be sorted based on these groups at 29 and 31. The user may alternatively specify other sorting at 33. The user can review the items included in the order either in a product line view or an item view at 35. The user can then review the transmittal to verify recipients and their addresses and other related information at 37. At this point, the order document editor is called as indicated at 39. Within the document editor 39, there is an editor for submittals 41 and for operation and maintenance manuals at 43. When editing is complete, the formatter provides for authorization of printing 45 which is described in more detail in connection with the flow chart of FIG. 3 and upon completion of this function generates reports at 47. These can include, for example, reports by product line for billing back the costs of the packages to the appropriate entities, reports on the number of packages generated, and other management reports.

The flow chart 45 for the authorized for printing function is shown in FIG. 3. This wizard guides the user through decisions on the formatting of the order document package. Beginning at 49, the user specifies section numbers for the product lines. If the document package is to be a submittal as determined at 51, a choice can be made between having a complete submittal or selecting individual categories, such as only certain types of drawings and/or documents, for the submittal at 53. Likewise, operation and maintenance manuals can either be complete or just include individual categories as indicated at 55. A complete manual can be generated either in draft or final copy at 57.

For all packages, the output, whether hard copy and/or an electronic copy (CD-ROM) is selected at 59. If binders are not required at 61, a table of contents can be added at 63. Tabs can be added at 65. Following this, the external printer can be notified automatically at 67 and the user's e-mail is validated at 69 for notification of print completion or errors. Upon completion of these tasks the print services module is called at 71.

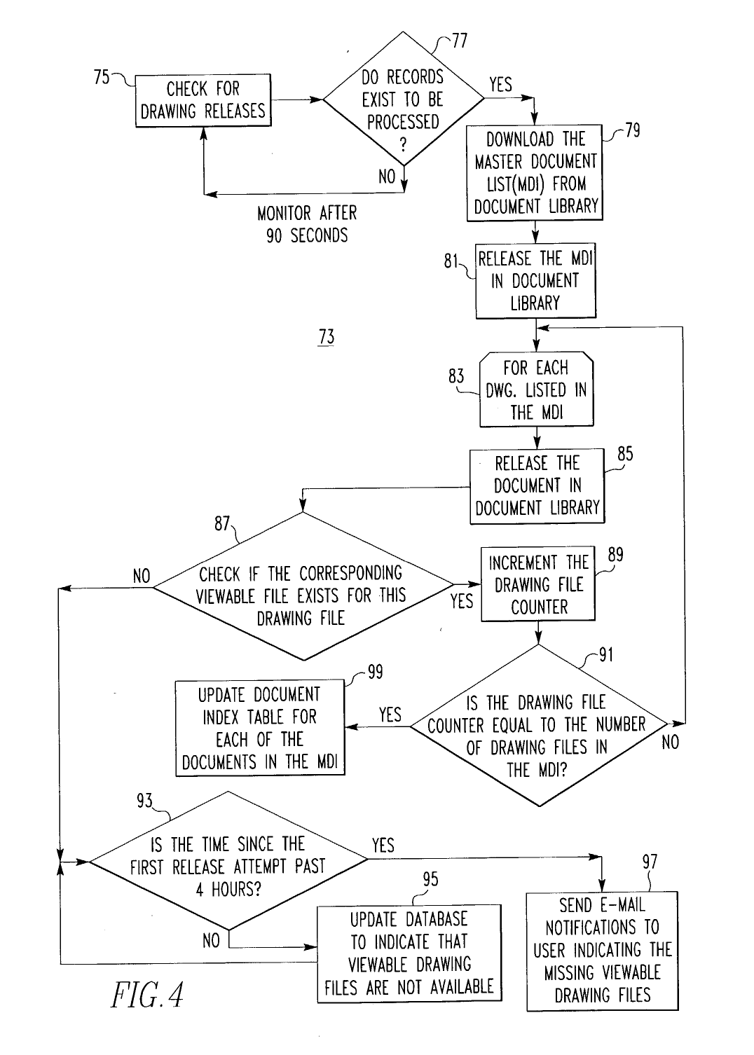

FIG. 4 is a flow chart of the document release service routine 73. This service checks for drawings to be released every 90 seconds at 75 and 77. When a drawing to be released is found, the master document list (MDL) is downloaded from the electronic document library at 79. This MDI is updated and released back into the document library at 81. For each drawing listed in the MDI at 83 that has changed or is new, the drawing is released into the document library at 85. If a corresponding viewable file exists for the drawing as determined at 87, the drawing file counter is incremented at 89. If there are additional drawing files to be released at 91, the program loops back to process the next drawing at 83.

If a viewable file does not exist at 87, a period of time such as four hours is allowed for it to be provided by the plant user at 93. If the allowable time period is not expired, the database is updated at 95 to indicate that the viewable drawing is not available. On the other hand, if the allowable time period has expired at 93 then an e-mail is sent to the user at 97 to indicate that the viewable drawing file is missing. When all of the drawings have been released with viewable files, the document index table is updated at 99.

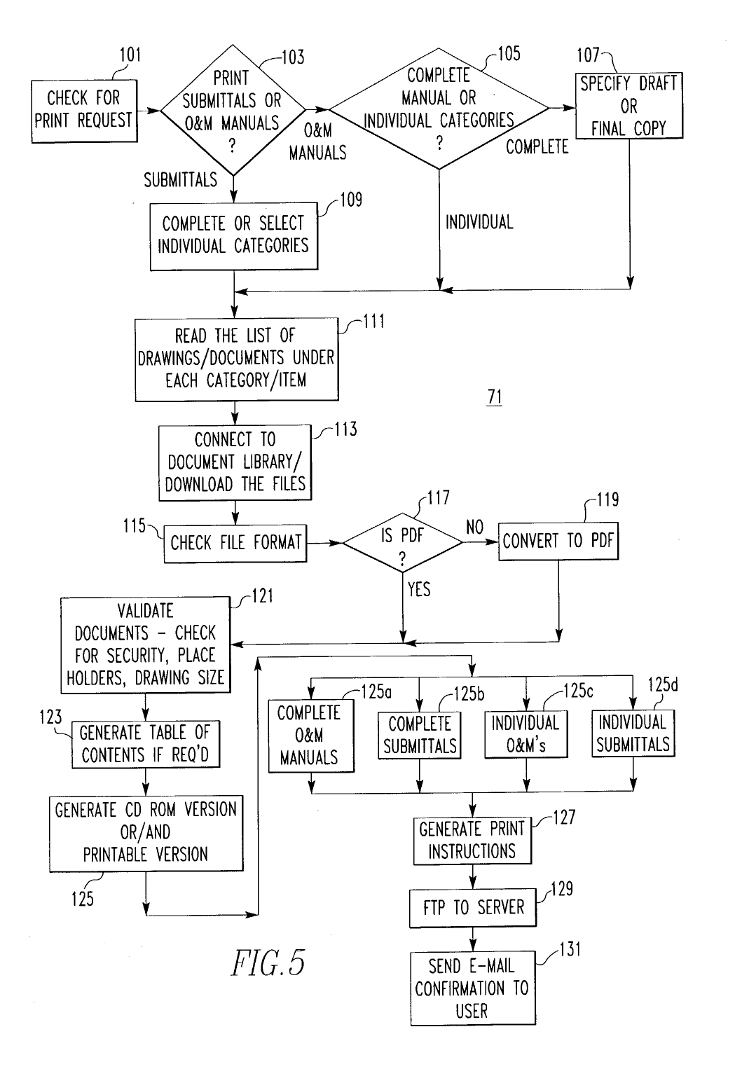

FIG. 5 illustrates the flow chart 71 for the document printing service 19. When a print request is received at 101, the type of document that was selected is read at 103. If the order document is an operation and maintenance manual, whether a complete or individual category manual is required and whether a file or draft copy was indicated are read at 105 and 107. Similarly, the type of submittal is read at 109. The list of documents required under each category/item is then read at 111 and the files for those documents are downloaded from the document library at 113. The file format is checked at 115 and if it is not PDF, as determined at 117, it is converted to PDF at 119. The documents are then validated at 121. This involves a check for security, the placement of holders for missing documents and a correct drawing size. A table of contents, if required, is developed at 123. The output version, CD-ROM and/or printable version are then generated at 125. The respective files for the principle types of packages are indicated at 125a, 125b, 125c and 125d. Print instructions are then generated at 127 and transmitted to the server at 129. An e-mail confirmation is then sent to the user at 131.

The invention reduces the burden on sales personnel in the production of the voluminous document packages needed for complex engineered equipment and mixed apparatus orders. It also produces more uniform yet flexible packages that can be printed by commercial printers resulting in significant economies.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A system for generating document packages for complex engineered equipment and mixed apparatus orders, comprising:
an order interface inputting an order document package including an identity of items ordered and a type of package ordered;
an electronic transmittal file identifying recipients of the order document package;
an electronic document library storing documents associated with items available for order including drawing documents;
a editor identifying order documents needed for the order document package including drawing documents present in the electronic document library and any additional drawing documents needed but not in the electronic document library;
a formatter establishing a selected format for the order documents for the type of package ordered;
a plant interface providing access to the identity of items ordered and associated drawing documents in the electronic document library and for inputting the any additional drawing documents needed for the order document package; and
a document print service generating from the electronic document library a file comprising the order documents and producing for the identified recipients an output of the order documents in the selected format.

2. The system of claim 1, wherein the document print service comprises means producing at least one output selected from a group comprising, a printed document package, an electronic document package on an electronic storage medium, and an e-mail document package.

3. The system of claim 1, wherein the formatter comprises means for sorting the order documents in a selected pattern.

4. The system of claim 1, wherein the formatter comprises means for grouping the items ordered in groups, and sorting by the groups so that the order documents for the items ordered are organized by group.

5. The system of claim 1, wherein the formatter comprises means for generating a selected format for each type of document package ordered.

6. The system of claim 5, wherein the document packages comprise submittal packages and operation and maintenance manual packages and wherein the formatter comprises means generating a submittal format for order documents for the submittal package and an operation and maintenance manual format for order documents for the operation and maintenance manual package.

7. The system of claim 1, wherein the formatter comprises means for generating a table of contents for the order documents.

8. The system of claim 1, wherein the document print service comprises means generating place holders for missing order documents.

9. A method for generating document packages for complex engineered equipment and mixed apparatus using digital computer means, comprising the steps of:
generating an electronic document library containing documents associated with items available for order including drawing documents;
generating an electronic order file for an order document package comprising identity of items ordered and a type of document package ordered;
using the electronic order file to electronically identify order documents needed for the order document package including drawing documents present in the electronic document library and any additional drawing documents needed but not in the electronic document library;
establishing a selected format for the order documents based on the type of document package ordered;
providing plant access to the identity of the items ordered and to associated drawing documents in the electronic document library for inputting the any additional drawing documents needed as order documents for the order document package;
generating from the electronic document library an electronic order document file containing the order documents; and
generating from the electronic order document file an output comprising the order documents in the selected format.

10. The method of claim 9, wherein generating an output comprises electronically producing at least one output selected from a group comprising, a printed document, an electronic file on an electronic storage medium, and an e-mail message.

11. The method of claim 9, wherein generating an output comprises electronically transmitting the electronic order document file to a remote site and generating from the electronic order document file at the remote site a printed document comprising the order documents in the selected format.

12. The method of claim 1, wherein establishing a selected format comprises sorting the item ordered in a selected pattern.

13. The method of claim 12, wherein sorting the items ordered in a selected pattern comprises grouping the items ordered into groups and sorting by groups so that the order documents for the items ordered are arranged by the groups.

14. The method of claim 13, wherein the items ordered are selected from a plurality of product groups and wherein the sorting is by product group.

15. The method of claim 12, wherein the type of package ordered comprises an operation and maintenance manual and establishing a selected format comprises organizing the order documents as an operation and maintenance manual.

16. The method of claim 15, wherein establishing a selected format comprises arranging the ordered documents in volumes.

17. The method of claim 15, wherein the ordered documents are selected from a group comprising drawings, bills of material, test reports, specification sheets, and sales literature.

18. The method of claim 12, wherein establishing a selected format comprises generating a table of contents for the order documents in the document package.

19. The method of claim 12, wherein establishing a selected format comprises generating tabs for the order documents in the document package.

20. The method of claim 9, wherein inputting the any additional drawing documents comprises inputting for each drawing document a complete electronic version and a viewable electronic version of the drawing and releasing for retrieval from the electronic document library only drawings for which both the complete electronic version and the viewable electronic version exists in the electronic document library.

21. The method of claim 9, wherein generating an electronic order document file comprises inserting place holders for missing documents.
